(19) United States
(12) Patent Application Publication
(10) Pub. No.: US 2017/0352228 A1
(43) Pub. Date: Dec. 7, 2017

(54) Crane Machine with Camera and Visual Targeting Assistance

(71) Applicant: Glenn Kramer, Lakewood, NJ (US)

(72) Inventor: Glenn Kramer, Lakewood, NJ (US)

(21) Appl. No.: 15/614,660

(22) Filed: Jun. 6, 2017

Related U.S. Application Data
(60) Provisional application No. 62/345,907, filed on Jun. 6, 2016.

(51) Int. Cl. G07F 17/32; A63F 9/30; A63F 9/24

(52) U.S. Cl. CPC G07F 17/3211; G07F 17/3295; A63F 9/30; A63F 2009/2463; A63F 2300/1093

(57) ABSTRACT

Game machine having a housing with a number of upright walls, said housing being adapted to accommodate playing means, for instance pick-up means such as a claw. The claw in the game has a camera mounted in the claw and pointing down. The image from camera is shown on the back wall of the crane so the customer can see it while it is falling toward the toys.

### FEDERALLY SPONSORED RESEARCH

Not Applicable

### SEQUENCE LISTING OR PROGRAM

Not Applicable

### CROSS REFERENCE TO RELATED APPLICATIONS

This application claims priority from U.S. patent application Ser. No. 62/345,907, entitled “Crane Machine with Camera and Visual Targeting Assistance”, filed on Jun. 6, 2016. The benefit under 35 USC §119(e) of the United States provisional application is hereby claimed, and the aforementioned application is hereby incorporated herein by reference.

### TECHNICAL FIELD OF THE INVENTION

The present invention relates generally to an amusement machine. More specifically, the present invention relates to a crane and claw amusement machine.

### BACKGROUND OF THE INVENTION

Skill cranes have been in use for many years wherein a plurality of various prizes are contained within a cabinet having a claw mechanism contained therein, and actuated by a person outside of the cabinet, whereby an attempt is made to grasp and retrieve one of the prizes from the cabinet within a predetermined period of time.

### SUMMARY OF THE INVENTION

The claw in the game of the present invention has a camera mounted in the claw and pointing down. The image from camera is shown on the back wall of the crane so the customer can see while it is falling toward the toys.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIGS. 1-3 are images of the camera mounted to the movable claw apparatus of a prototype machine of the present invention.

FIGS. 4-5 are images of the display mounted to the back wall of the cabinet showing a target locator display and cross hairs overlaid of the camera image of where the crane is currently located over the playing area of a prototype machine of the present invention.

FIG. 6 is an image of the camera mounted to the movable claw apparatus of a prototype machine of the present invention.

FIGS. 7-8 are images of the display mounted to the back wall of the cabinet showing a target locator display and cross hairs overlaid of the camera image of where the crane is currently located over the playing area of a prototype machine of the present invention.

FIGS. 9-13 are images of the cabinet of a prototype machine of the present invention.

FIG. 14 is an image of the display mounted to the back wall of the cabinet showing a target locator display and cross hairs overlaid of the camera image of where the crane is currently located over the playing area of a prototype machine of the present invention.

FIG. 15 is an image of the camera mounted to the movable claw apparatus of a prototype machine of the present invention.

FIGS. 16-17 are images of the display mounted to the back wall of the cabinet showing a target locator display and cross hairs overlaid of the camera image of where the crane is currently located over the playing area of a prototype machine of the present invention.

FIG. 18 is an image of the camera mounted to the movable claw apparatus of a prototype machine of the present invention.

FIG. 19 is an image of the camera mounted to the movable claw apparatus and user control/engagement/playing panel of a prototype machine of the present invention.

FIGS. 20-22 are images of the display mounted to the back wall of the cabinet showing a target locator display and cross hairs overlaid of the camera image of where the crane is currently located over the playing area of a prototype machine of the present invention.

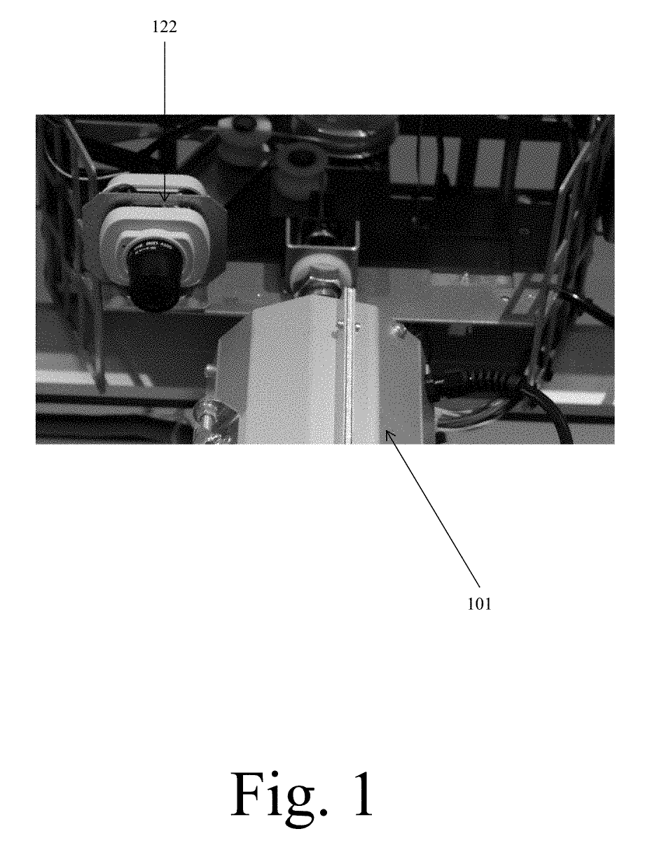

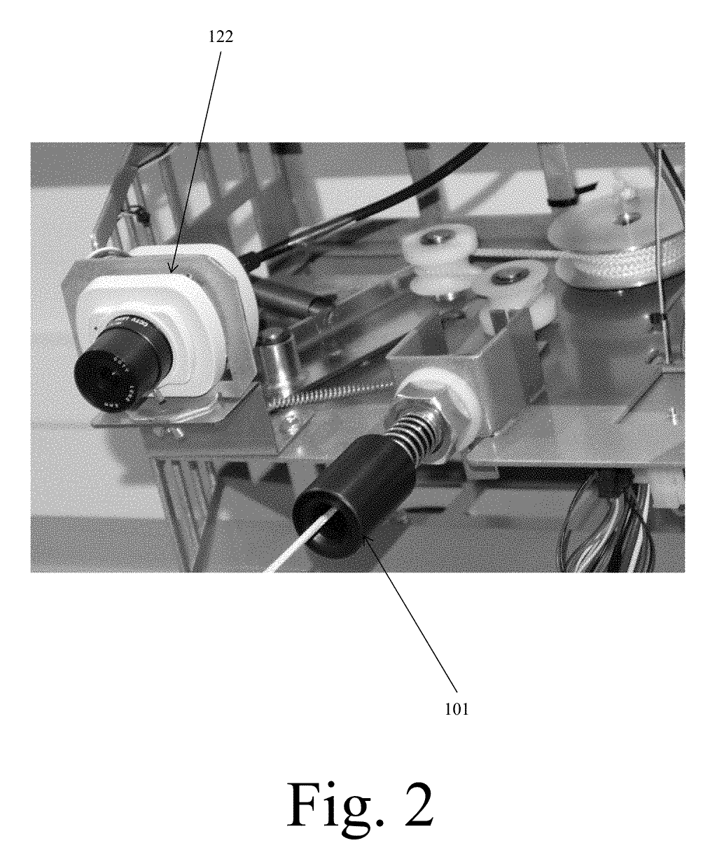

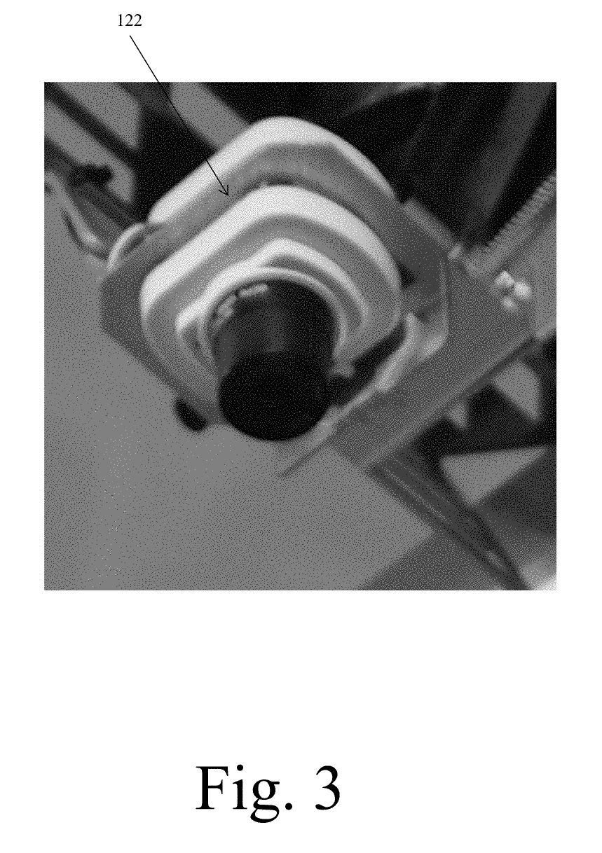

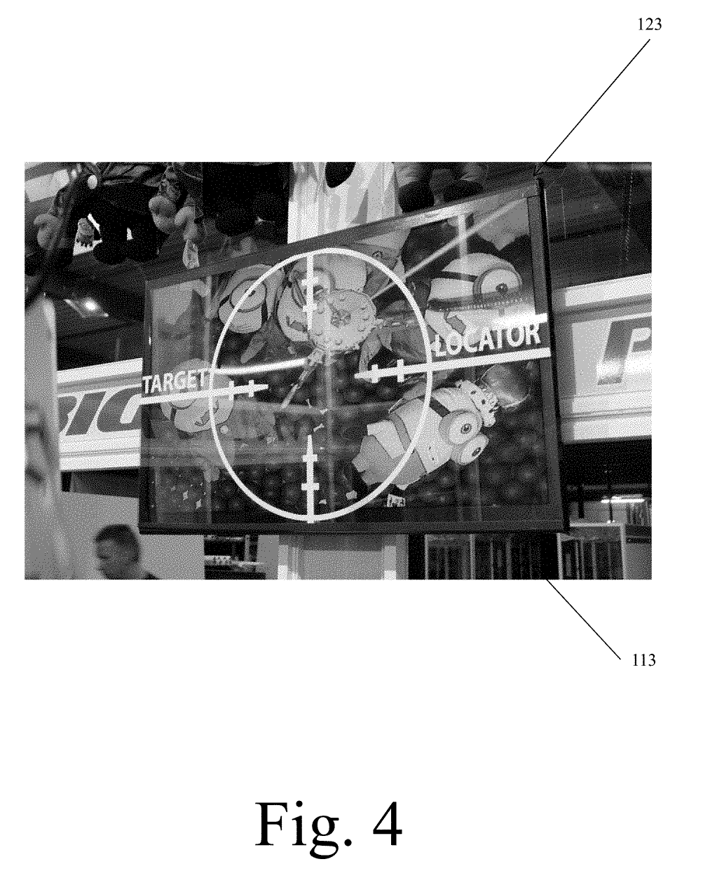

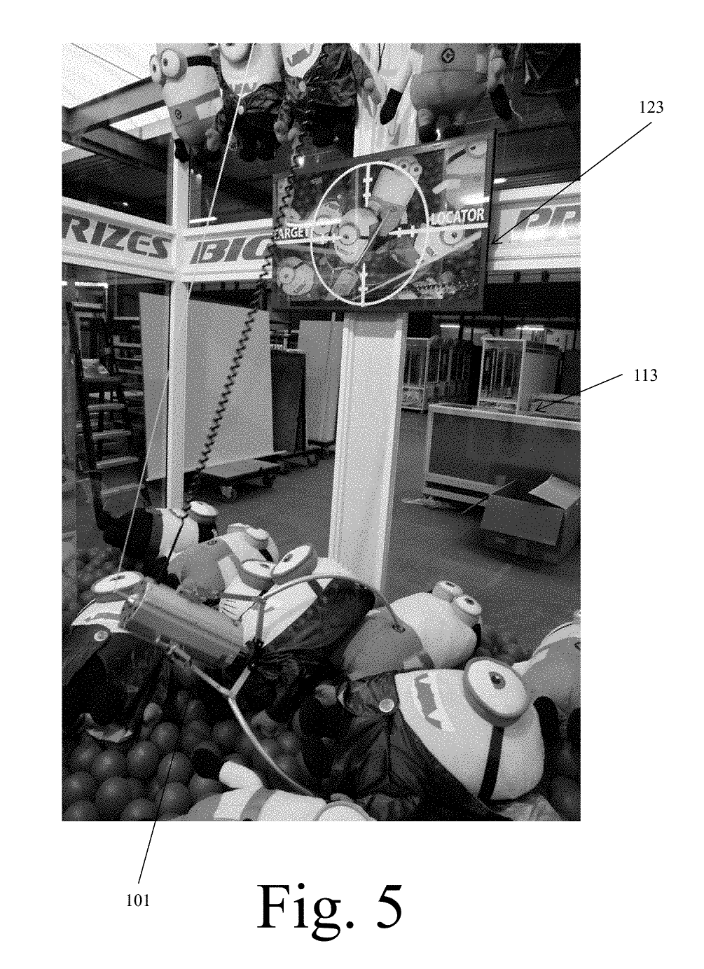

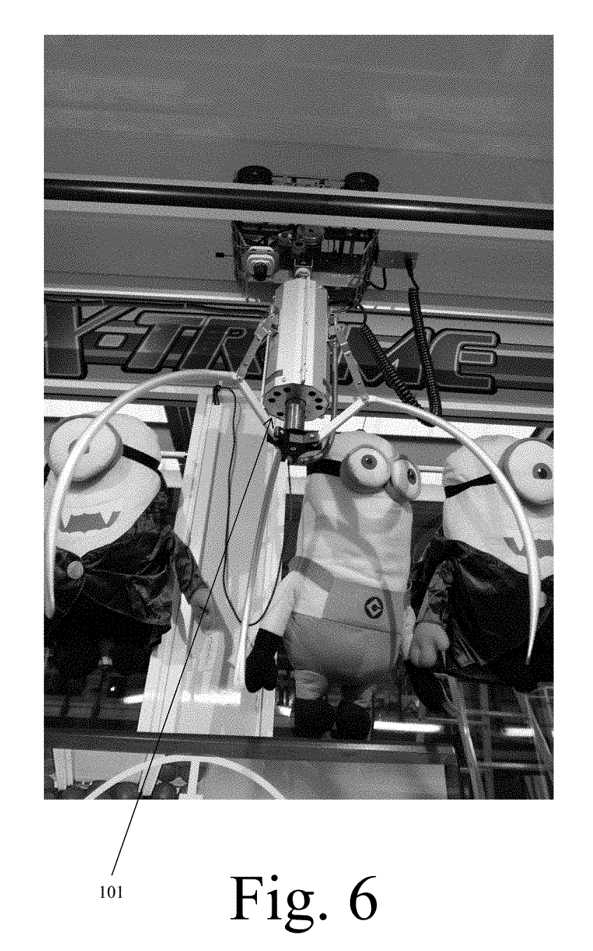

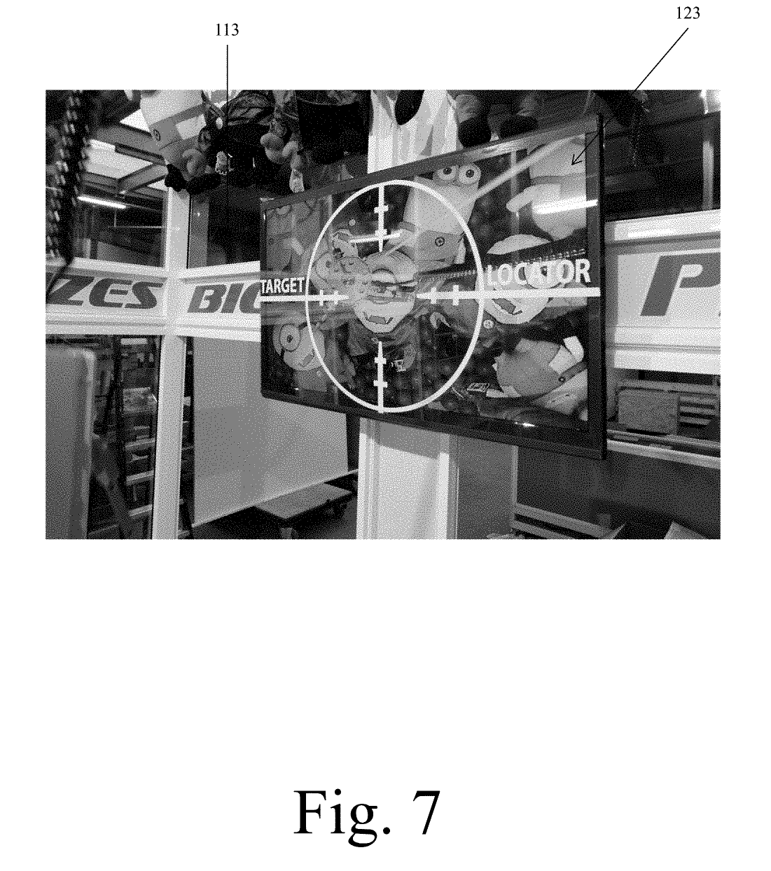

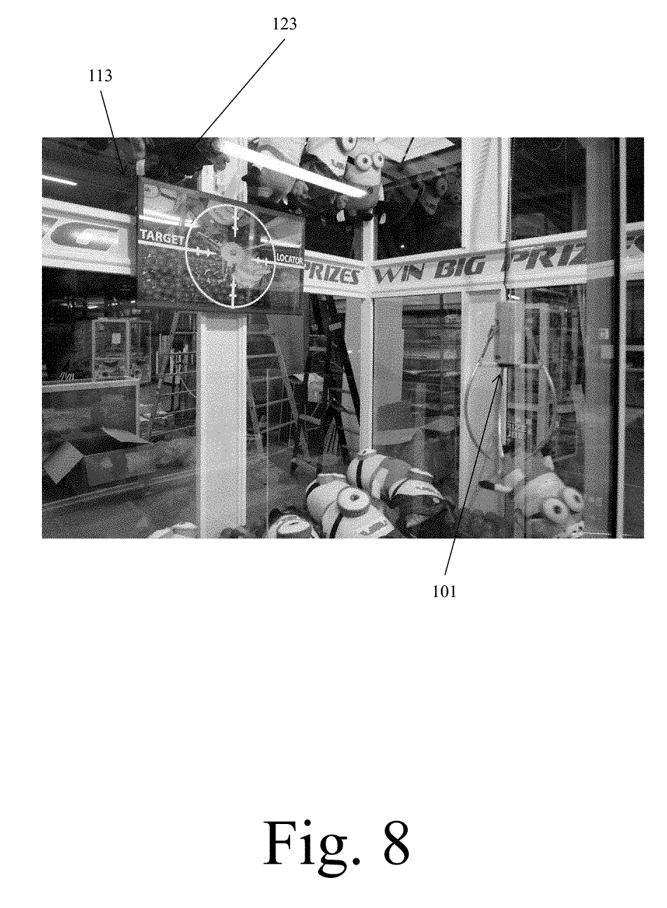

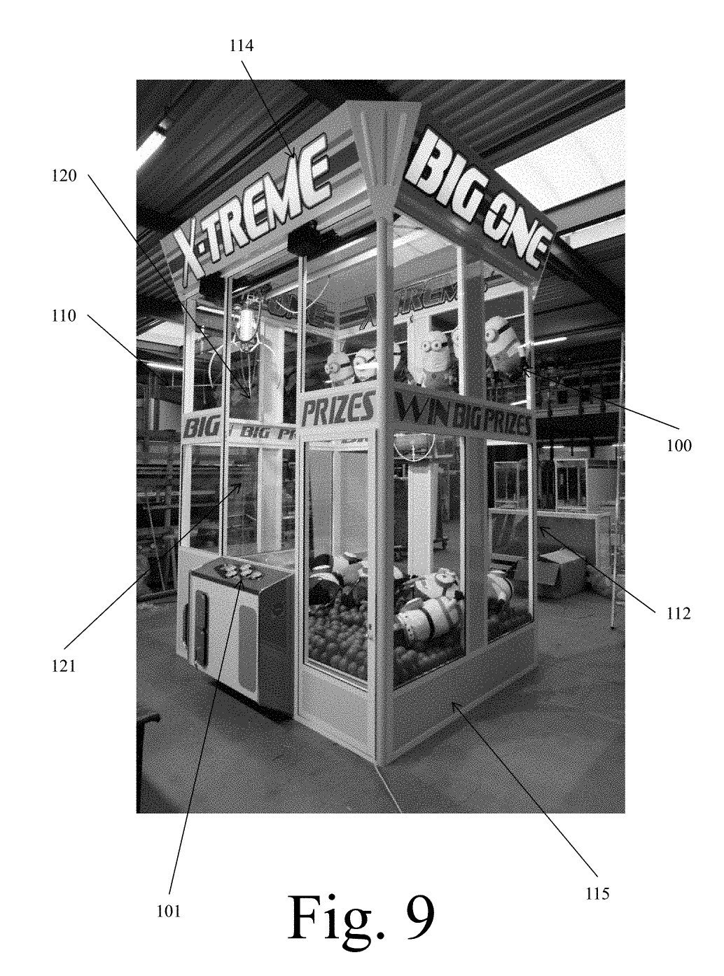

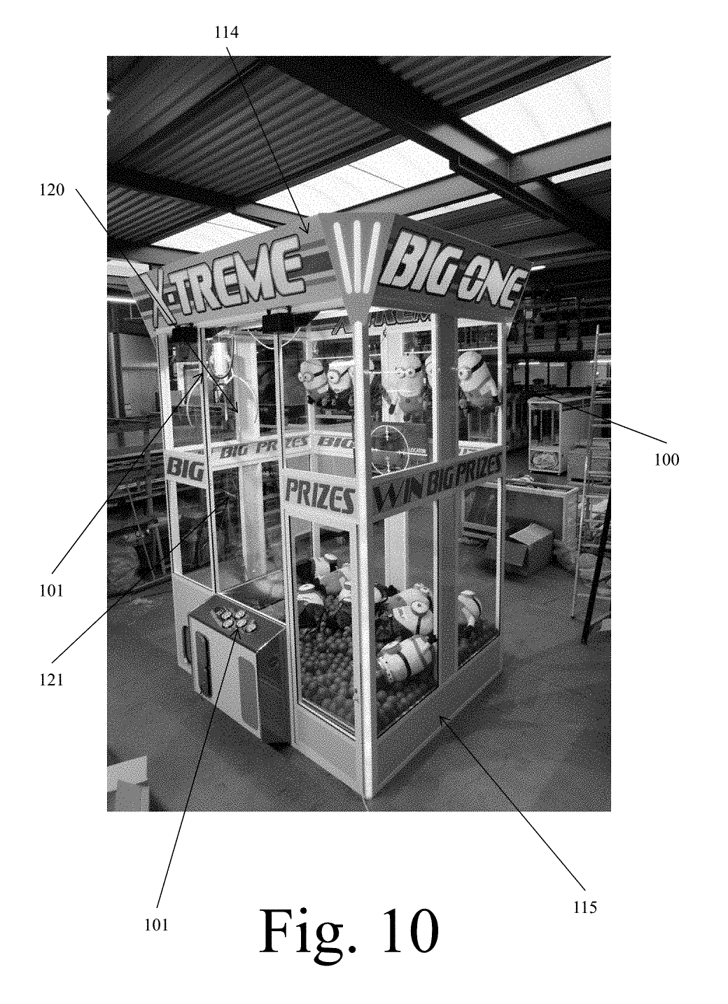

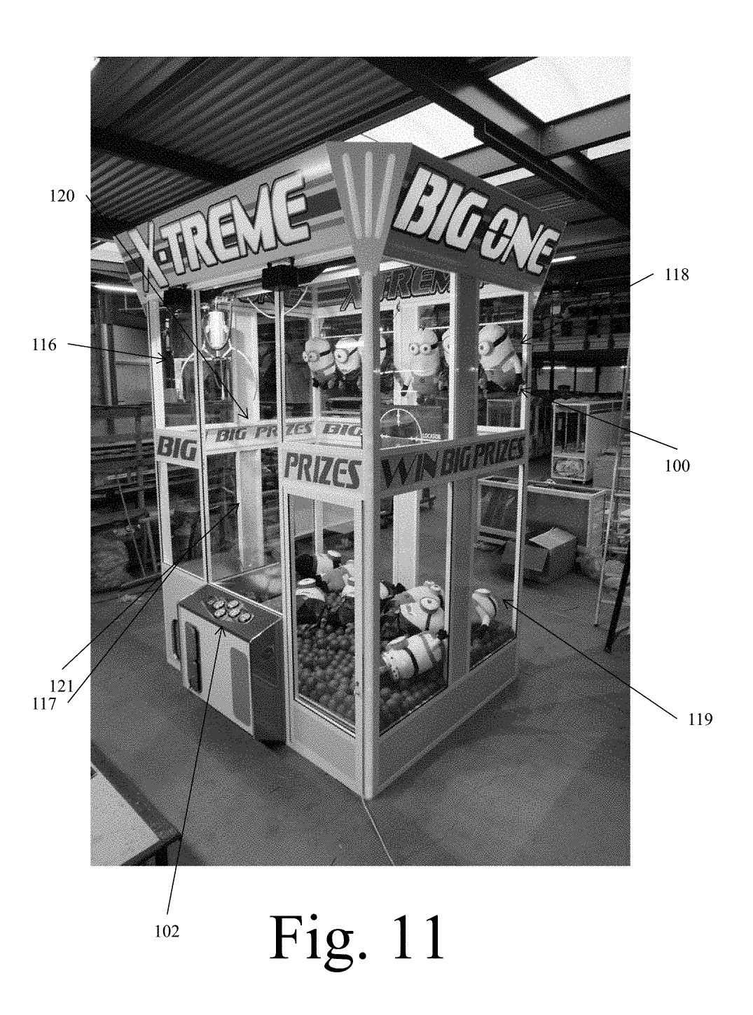

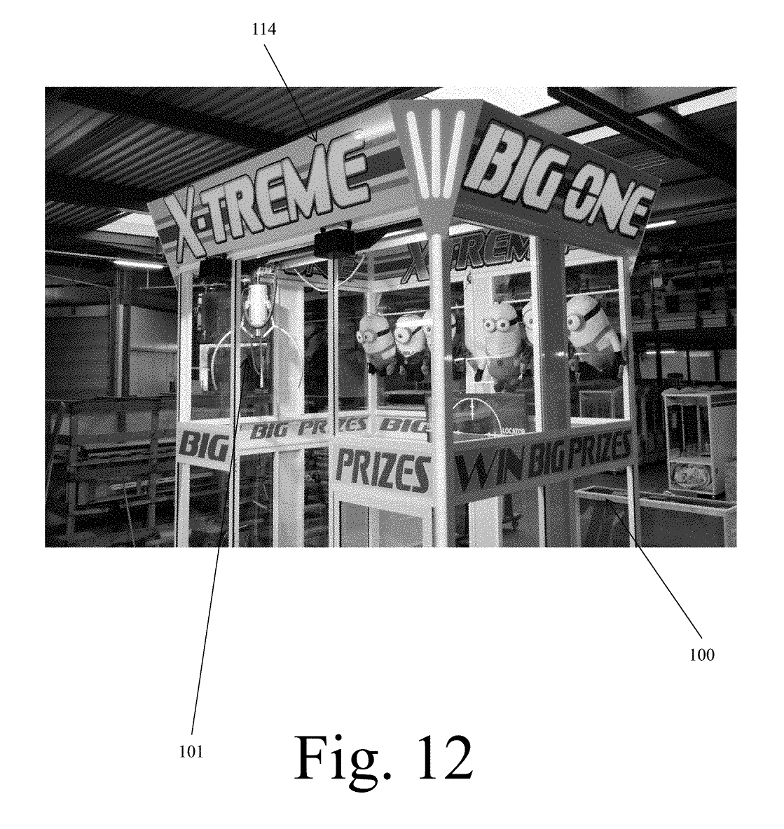

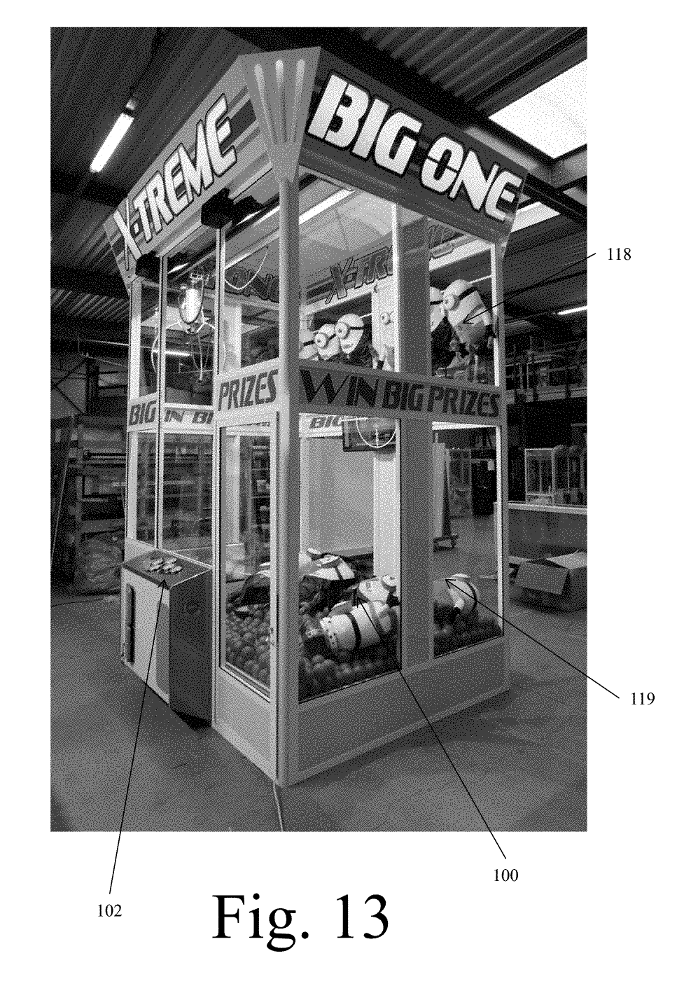

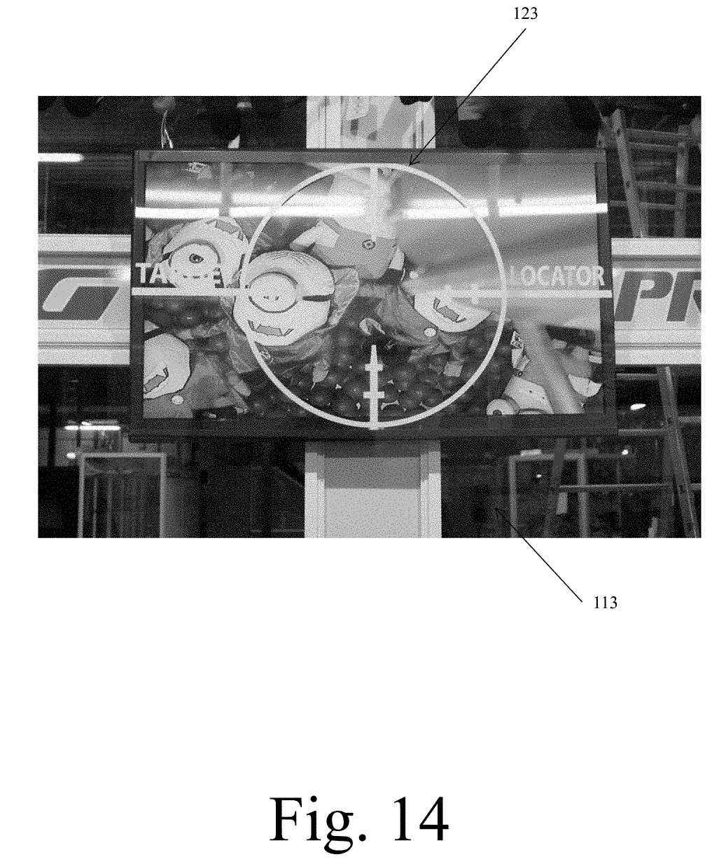

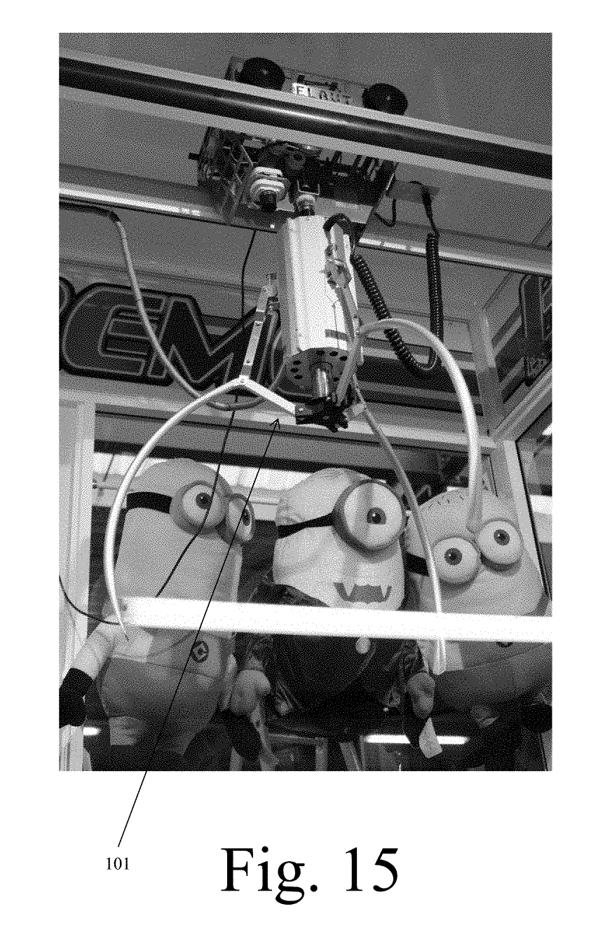

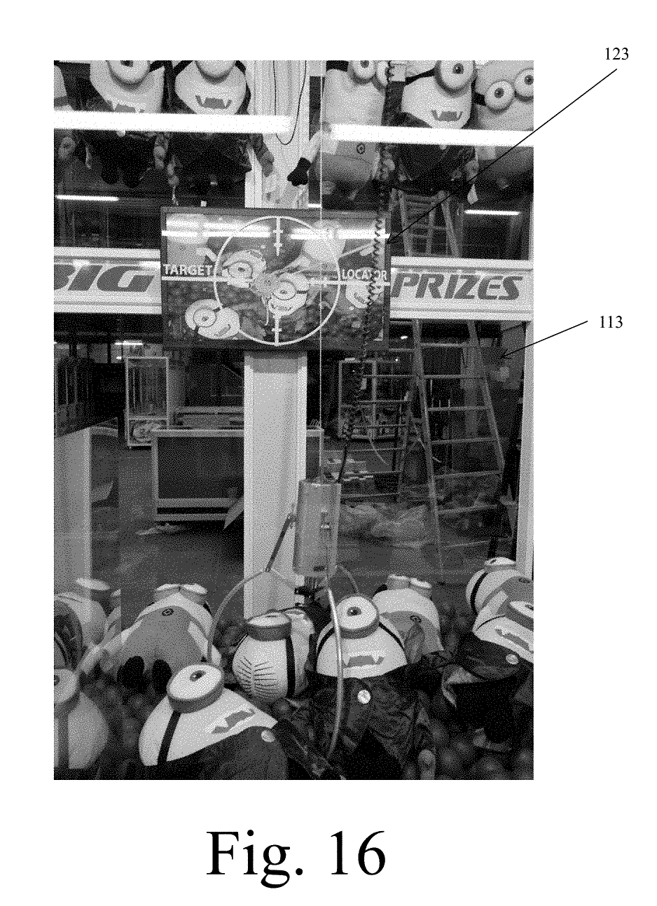

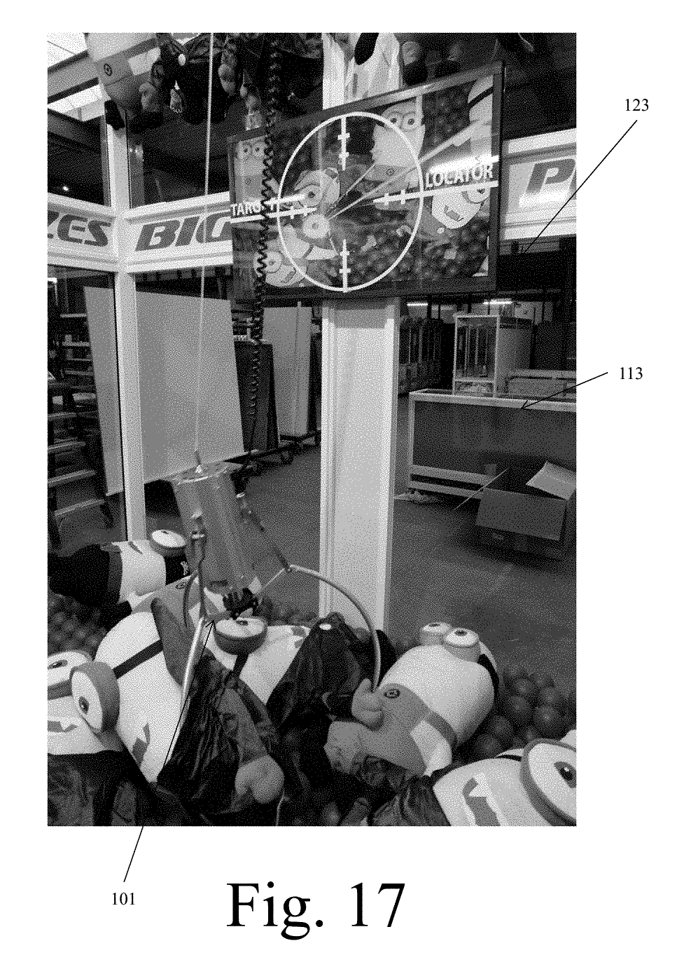

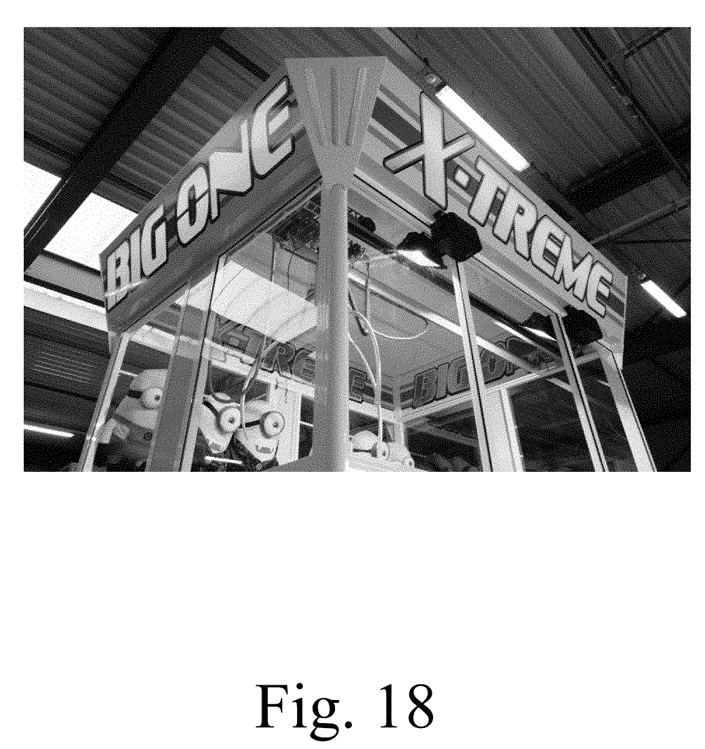

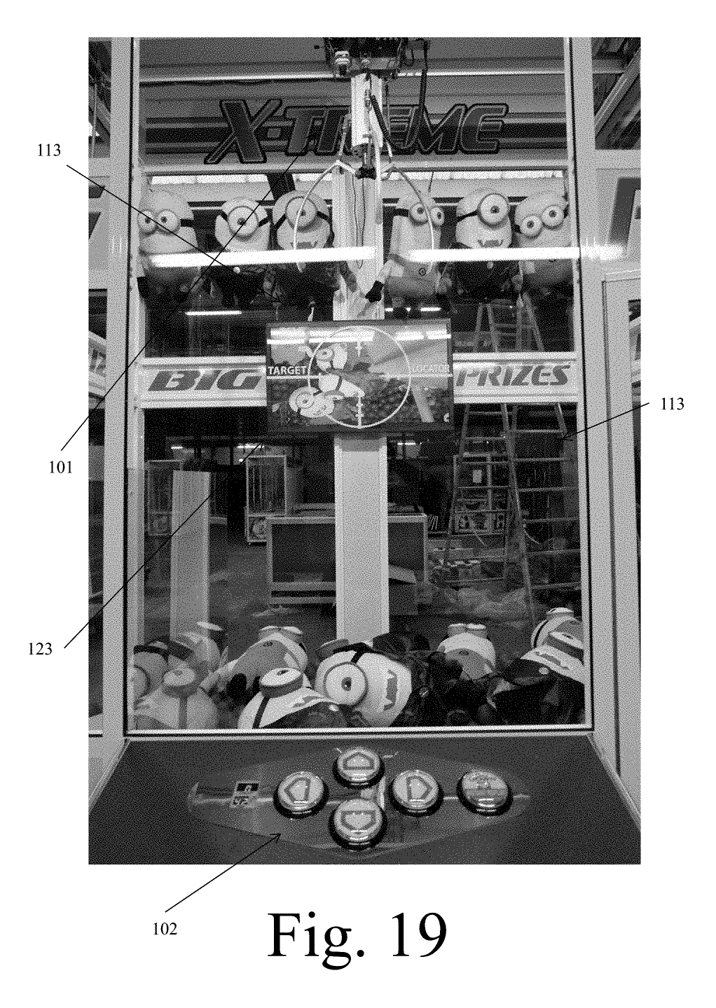

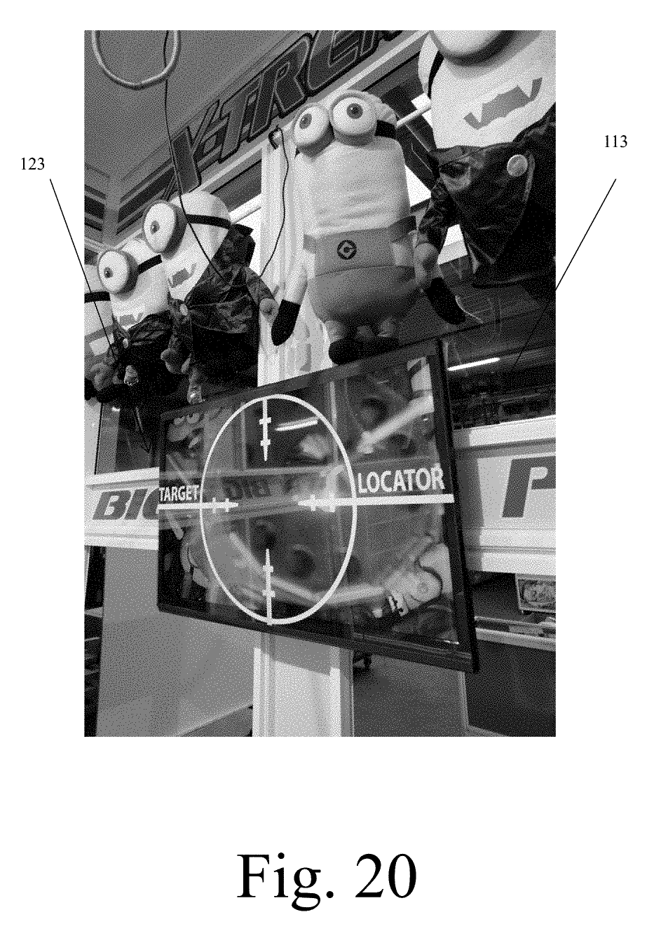

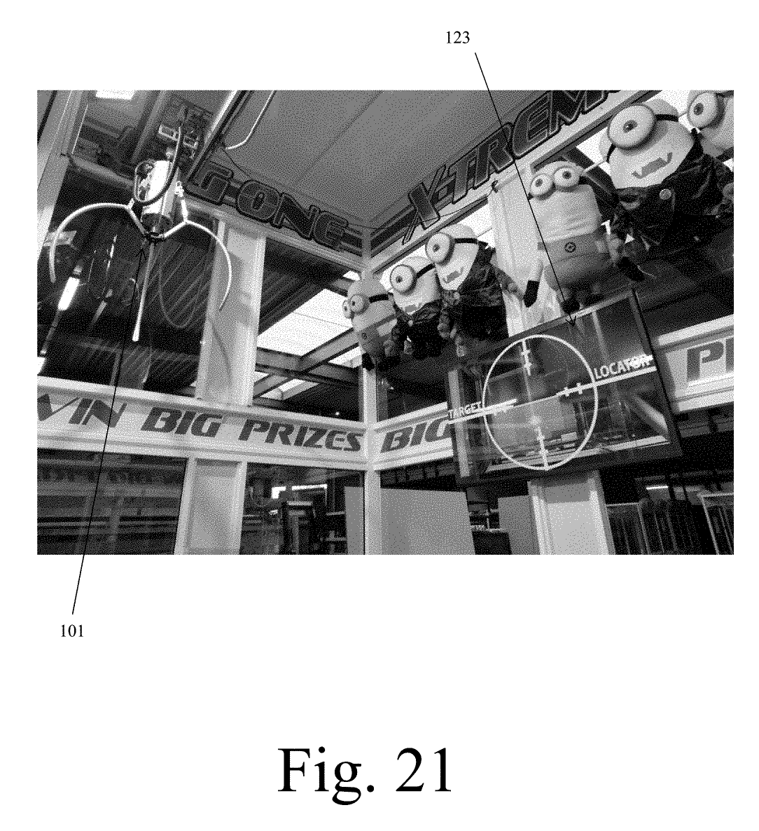

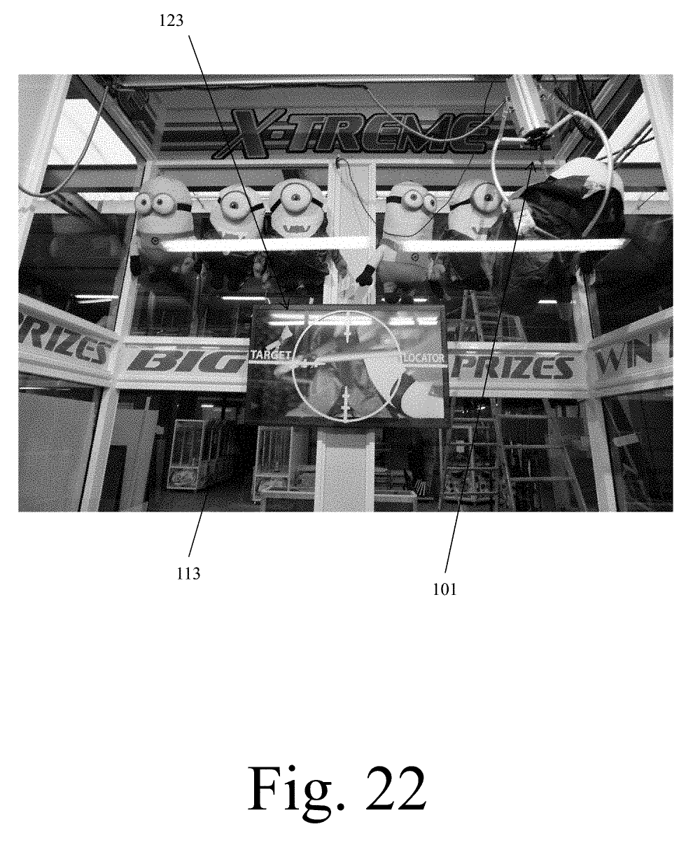

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Skill cranes and other amusement vending machines are typically found in retail locations where children are present. Such locations often include grocery stores, theme restaurants, game arcades, and the like.

Conventional skill crane games typically include a transparent cabinet 100 that holds a plurality of prizes, such as stuffed toy animals, capsulated items, candy, etc. A movable claw or other grasping device 101 is positioned inside the cabinet 100, and is operably connected to a joystick or a series of buttons 102 mounted on the outside of the cabinet 100. After inserting the required amount of money, the player attempts to grab a prize by moving the open claw 101 into position with the joystick or series of buttons 102 and releasing it. If the player has skillfully positioned the claw 101 over the desired toy or prize, then the claw 101 will descend onto the toy and grasp it. The claw 101 then transfers the toy to an outlet chute from which the player can retrieve the toy. With all the toys mixed together in a pile, however, it is often difficult for the player to determine exactly which toy the claw 101 is hovering over before dropping the claw 101. As a result, the player is often unsuccessful at grabbing a toy.

Some skill crane games limit the amount of time the player has to grab a prize. If the player does not grab a prize in the given time, then the player must insert more money into the machine for continued play. Other skill crane games give the player a single opportunity to drop the claws over a desired toy in an attempt to grasp a prize. If the player is unsuccessful, then the player must insert additional money for continued attempts. Given the difficulty of grabbing a toy on the first or second try, many players become discouraged by these game formats and do not return to play the game again.

Although a specific embodiment of a game machine with a grabber or claw 101 is described here, the skilled person will appreciate that the measures of the invention are also applicable to any other game machine in which other game means are provided in a cabinet or housing, wherein it is for instance possible to envisage coin and token games and games of skill.

The cabinet 100 consists essentially of a front wall 110, two side walls 111 and 112, a rear wall 113, an upper wall 114, and a bottom 115. The front wall 110 here consists essentially of an upper transparent panel 116, a lower translucent panel 117. Each side wall 111 and 112 likewise comprises an upper transparent panel an upper transparent panel 118 and 120, a lower translucent panel 119 and 121.

Now referring to Figures, one embodiment of the present invention is shown. The claw 101 in the game of the present invention has a camera 122 mounted in the claw 101 and pointing down. The image from camera is shown on a monitor 123 mounted on the back wall 113 of the crane so the customer can see while it is falling toward the toys.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A crane machine comprising:
a cabinet;
the cabinet comprising
a front wall
two side walls,
a rear wall,
an upper wall, and
a bottom;
at least one prize positioned within the cabinet;
a user-operable prize selecting device movably positioned within the cabinet;
wherein the claw in the game has a camera mounted in the claw and pointing down; and
a monitor displaying the image from the camera.

2. The crane machine of claim 1, wherein
the front wall comprising an upper transparent panel, and a lower translucent panel.

3. The crane machine of claim 1, wherein
each of the side walls comprising an upper transparent panel,

4. The crane machine of claim 1, wherein
The user-operable prize selecting device movably positioned within the cabinet is a claw.

5. The crane machine of claim 1, wherein
the image from the camera is shown on the monitor so the customer can see where it will land while it is falling toward the toys.

6. The crane machine of claim 1, wherein
the monitor is positioned on the back wall of the cabinet.

7. The crane machine of claim 1, wherein
the image from the camera is shown on the back wall of the crane so the customer can see where it will land while it is falling toward the toys.

8. The crane machine of claim 1, wherein
the at least one prize is visible from outside the cabinet through the transparent portion;
